(19) United States
(12) Patent Application Publication
(10) Pub. No.: US 2006/0164703 A1
(43) Pub. Date: Jul. 27, 2006

(54) Method for modifying spatial resolution in the resolution in the reconstruction of images in digital holography

(76) Inventors: Giuseppe Coppola, Rome (IT); Sergio De Nicola, Rome (IT); Pietro Ferraro, Rome (IT); Andrea Finizio, Rome (IT); Giovanni Pierattini, Rome (IT)

Correspondence Address: Hedman & Costigan, 1185 Avenue of the Americas, New York, NY, 10036-2646, US

(21) Appl. No.: 10/566,036

(22) PCT Filed: Jul. 9, 2004
(86) PCT No.: PCT/IT04/00380

§ 371 Date: Jan. 25, 2006

(30) Foreign Application Priority Data
Aug. 13, 2003 (IT) RM 2003 A 000398

(51) Int. Cl. G02B 5/32

(52) U.S. Cl. 359/15

(57) ABSTRACT

The invention concerns a method Method for the reconstruction of holographic images, the holographic image being detected by an image detection device (9), the holographic image being transformed in a digitized hologram (10), the digitized hologram (10) being comprised of a number Vᵣ of elementary pixels, the size of which being equal to the holographic image sampling intervals, and of the Vᵣ values (51) respectively associated to the elementary pixels, the method comprising a first step (11,12) of processing the digitized hologram array, and a second step (13,15,16,17,18) of hologram reconstruction in the observation plane starting from the digitized hologram processed in the first step, the method being characterised in that the second step is carried out through discrete Fresnel Transform applied on an array of Vₑ values corresponding to pixels having size equal to that of said elementary pixels, wherein said array of Vₑ values (50, 51) includes said array of Vᵣ values and an integer number p=Vₑ−Vᵣ>0 of constant values (50) equal to OS, said number Vₑ of values being inversely proportional to the desired pixel size to be obtained for the reconstructed image (14). The invention further concerns the instruments necessary to the execution of the method and the apparatus executing it.

The present invention refers to a method for modifying spatial resolution in the reconstruction of images in digital holography.

More particularly, the method according to the present invention allows the process of reconstruction of images employed in the interferometric technique of digital holography to be improved, thanks to the improvement of the spatial resolution of the reconstructed complex field, which allows upgrading applications of Digital Holography technique.

The interferometric technique, allowing recording and reconstructing the complex (amplitude and phase) field reflected, transmitted and/or scattered by an object, is commonly called in scientific literature as Digital Holography, which will be hereinafter abbreviated with the acronym DH (e.g. see: U.S. Pat. No. 6,262,818, to Cuche et al., entitled “Method for simultaneous amplitude and quantitative phase contrast imaging by numerical reconstruction of digital holograms”, and U.S. Pat. No. 6,246,495, to Yamaguchi, entitled “Phase-shift digital holographic apparatus”).

It is called digital hologram an interference pattern recorded by means of an integrated array of radiation detectors.

Several methods exist allowing the numerical reconstruction of the complex field starting from the hologram, and in particular there are the “convolution” method and the one called the “Fresnel” method.

In particular, in Fresnel method, as it is known, the spatial resolution of the complex field (or also amplitude and phase) is determined by some parameters. Some of these parameters are determined by the characteristics of the integrated array of radiation detectors and, in particular, by the number of elements of which the array is composed and by the size of the single element. Besides, other parameters are the reconstruction distance, determined by distance d at which the object (or points of its surface and its volume), and the wavelength λ of the light source, used for creating the hologram, which are employed in the numerical process of reconstruction.

Commonly, in literature, the spatial resolution is quantified by means of the “reconstruction pixel”, which is expressed as a length, and which will be hereinafter indicated with the acronym PR. The dimensions of the bidimensional PR, Δξ along the x-axis and Δη along the y-axis, depend on the aforementioned parameters through the following mathematic formulas:

$$Δ ξ = \frac{λ d}{N Δ x} \\ Δ η = \frac{λ d}{M Δ y} \qquad ( 1 )$$

where M is the number of acquired pixels (acquired by n image acquisition device) along the x-axis, N is the number of pixels along the y-axis, Δx and Δy are the pixel size along the two directions of x- and y-axis.

From this formula, it is clear that the complex field will have a PR of different value at different distances, under parity of the other parameters, and in particular the size of PR increases under the increase of the reconstruction distance. In such case, the spatial resolution with which the complex field is reconstructed will have an inferior spatial resolution. On the contrary, the spatial resolution will be superior at lower reconstruction distance since in this case the PR size decreases.

In other applications, as for example spectroscopic or scattering enquiries, it is required the recording of several holograms of the same object under the same conditions, but obtained with different source wavelengths (or with different sources at different wavelengths) (e.g. see the paper by M. K. Kim, “Wavelenght-scanning digital interference holography for optical section imaging”, Optics Letters, Vol. 24, Issue 23, 1999, page 1693). In such case, by applying the reconstruction process to the several holograms related to each wavelength, holograms will be obtained which are reconstructed with different spatial resolutions, since, as it appears clear from equation (1), the PR for each wavelength is different. In particular, the reconstruction resolution will be higher for lower wavelengths which give lower PR values and vice versa.

In the state of the art prior to the present invention, there exist some problems connected to the fact that the reconstruction resolution is rigidly determined by some parameters such as distance and wavelength. By way of example, some particularly problematic cases will be mentioned in the following.

In some applications, digital holography is used for analysing variations to which the object under observation is subject because of an external action (e.g. force, pressure, temperature change). The variations are measured in a quantitative way by subtracting the phase maps of two holograms recorded with the object in two different states (for example before and after the external disturbance action). This technique is called Digital Holographic Interferometry.

In these dynamic type observations, the distance between the object under observation and the detection device (e.g. a camera), at which the hologram is recorded, could unintentionally change, obtaining different holograms recorded with the object placed at different distances from the detection device. Hence, in order to observe the object always in focus, it is necessary to change the value of distance to be employed in the reconstruction process (see the paper by Ferraro et al. in Optics Letters, 28(14), (2003), 1257-1259) for each recorded hologram.

From equations (1), it results that the PR value is different for holograms reconstructed at different distances, and the spatial resolution, with which the object (in the complex field: amplitude and phase) is reconstructed in the various holograms, is consequently different. This avoids carrying out in a direct way a difference of phase obtained, for instance, with two holograms separately reconstructed at two different distances, by actually preventing digital holographic interferometry technique from being applied. In fact, since reconstruction resolution is different in the two holograms, it is then not possible to carry out a direct subtraction of the phase maps (a one-to-one correspondence among the points of the two maps does not exist).

In general, the change of either the wavelength or the distance between object and camera, may make the resolution with which it is possible to observe the object worst.

This generally prevents any direct subtraction of phase between the two reconstructed images for detecting and quantifying small physical-mechanical variations of the object. Such subtraction procedure is typically employed in the “holographic interferometry” technique allowing different states of the same object to be compared.

Similarly, in case of applications of colour DH with use of different wavelengths, images reconstructed with different wavelengths do not overlap since the PR of each reconstruction is different (e.g. see the paper by I. Yamaguchi, “Phaseshifting color digital holography”, Optics Letters, Vol. 27, Issue 13, July 2002, page 1108, and the paper by J. Kato et al., “Multicolor digital holography with an achromatic phase shifter”, Optics Letters, Vol. 27, Issue 16, 2002, page 1403.

The Applicant does not know effective solutions to the above problems.

In fact, as it results from literature, the methods presently employed for obtaining a better resolution in observation of objects make use of complex experimental apparatuses requiring particularly delicate calibration procedures (e.g. see: Indebetouw et al., Appl. Phys. Lett. 75, (1999) 2017-2019).

It is an object of the present invention to provide a method of reconstruction of the holographic image starting from a digitized hologram solving the above drawbacks and enabling further uses.

It is also an object of the present invention to provide apparatuses and tools necessary for the execution of the method that is object of the invention.

It is further object of the present invention an apparatus for acquiring and reconstructing holographic images making use of the method that is object of the invention.

It is specific subject matter of this invention a method for the reconstruction of holographic images, the holographic image being detected by an image detection device, the holographic image being transformed in a digitized hologram, the digitized hologram being made of a number Vᵣ of signal intensity values corresponding to as many elementary sub-images or “pixels” of the holographic image, the pixel sizes being equal to the holographic image sampling intervals, the method comprising a first step of processing the digitized hologram array, and a second step of hologram reconstruction in the complex plane starting from the digitized hologram processed in the first step, the method being characterised in that the second step is carried out through discrete Fresnel transform starting from an array of Vₑ values, comprising said Vᵣ values and an integer number p=Vₑ−Vᵣ>0 of constant values equal to OS, corresponding to as many pixels of sizes equal to the ones of the others.

Preferably according to the invention, said p constant values are null values (OS=0).

Still preferably according to the invention, said p values are arranged externally to said array of Vᵣ values.

Always according to the invention, said p values may be arranged in a symmetrical way or in a non-symmetrical way.

Preferably according to the invention, said number Vₑ of values is inversely proportional to the desired pixel size to be obtained for the reconstructed image.

Preferably according to the invention, the digitized hologram the digitized hologram is a square array of Vᵣ=NᵣMᵣ values, each value corresponding to a square pixel of sizes Δx, Δy.

Still preferably according to the invention, the hologram reconstructed in the second step is represented by a square array of Vₑ=NₑMₑ values, each value corresponding to a square pixel of sizes Δξ=(λd/NₑΔx) and Δη=(λd/MₑΔy), λ being the wavelength of the wave beam striking the object of which the hologram is recorded, and d the distance between the detection device and the object of which the hologram is detected, Δξ and Δη being the reconstructed holographic image sampling intervals.

According to the invention, formulas Nₑ=(λd/Δx²), Mₑ=(λd/Δy²), Δξ=Δx, Δη=Δy may be valid.

Advantageously according to the invention, if each holographic image sampling interval is not equal or less than a certain threshold, the number of values p added to the digitized hologram array is increased and the second step is carried out again.

Preferably according to the invention, said threshold is a function of the signal-to-noise ratio of the holographic image.

It is further specific subject matter of the present invention a computer program characterised in that it comprises code means apt to execute, when running on a computer, the method subject of the invention.

It is still specific subject matter of the invention a memory medium, readable by a computer, storing a program, characterised in that the program is the computer program subject of the invention.

It is further specific subject matter of the invention an apparatus for detection of holographic images, comprising a digitized hologram processing unit, characterised in that the processing unit processes the detected data by using the method subject of the invention.

The invention will be now described, by way of illustration and not by way of limitation, by particularly referring to the drawings of the enclosed Figures, in which:

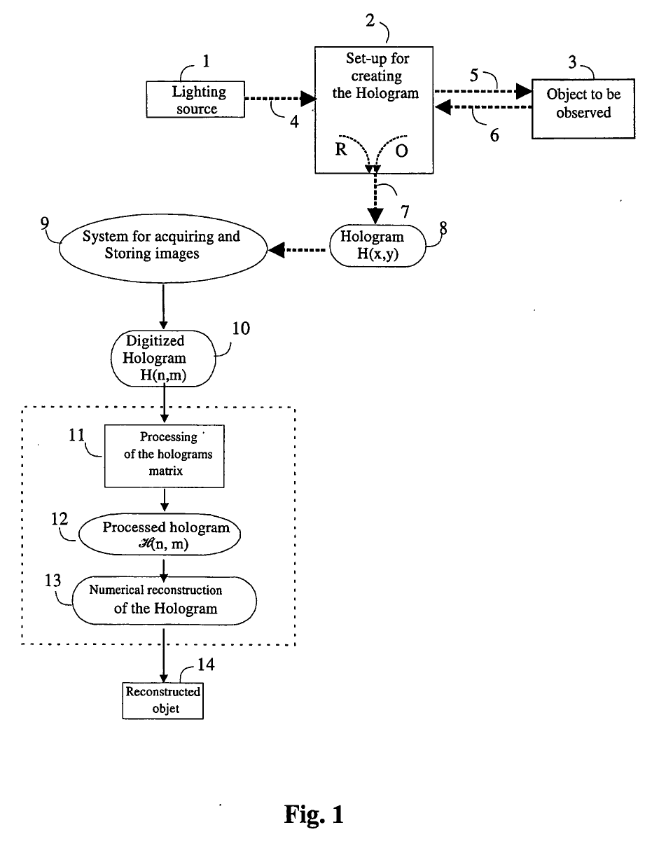

FIG. 1 shows a block and flow hybrid diagram of the traditional holographic reconstruction method;

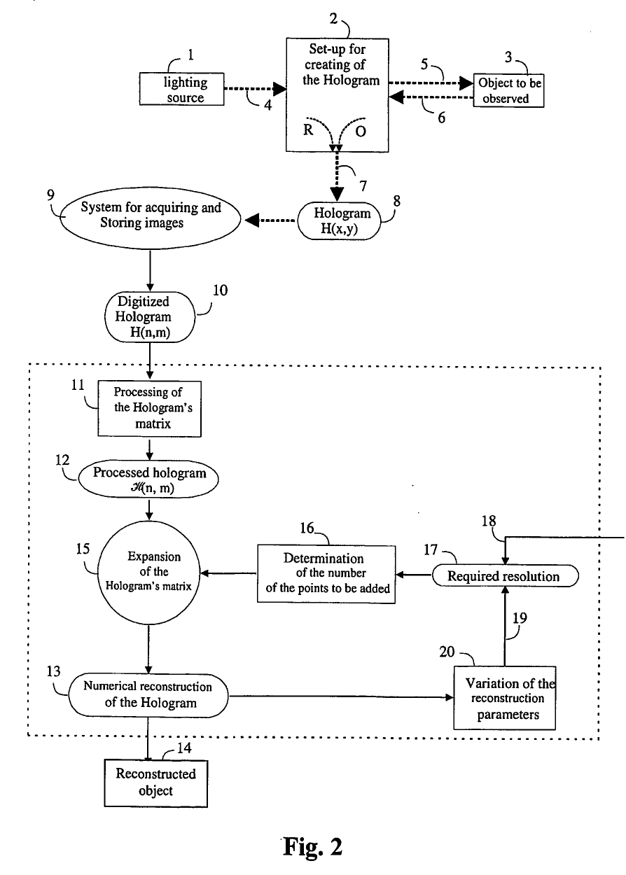

FIG. 2 shows a block and flow hybrid diagram describing the holographic reconstruction method according to the invention;

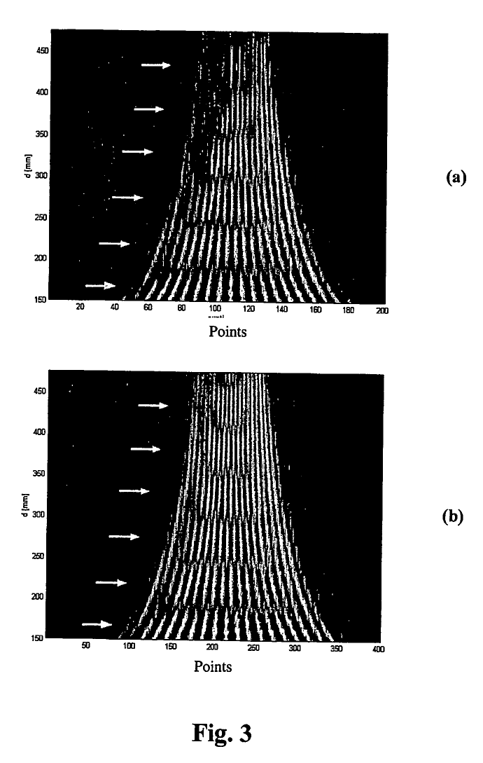

FIG. 3a shows the effect of the reconstruction in amplitude of a Talbot effect Ronchi grating made through the traditional method;

FIG. 3b shows the effect of the reconstruction in amplitude of a Talbot effect Ronchi grating made through the method according to the invention;

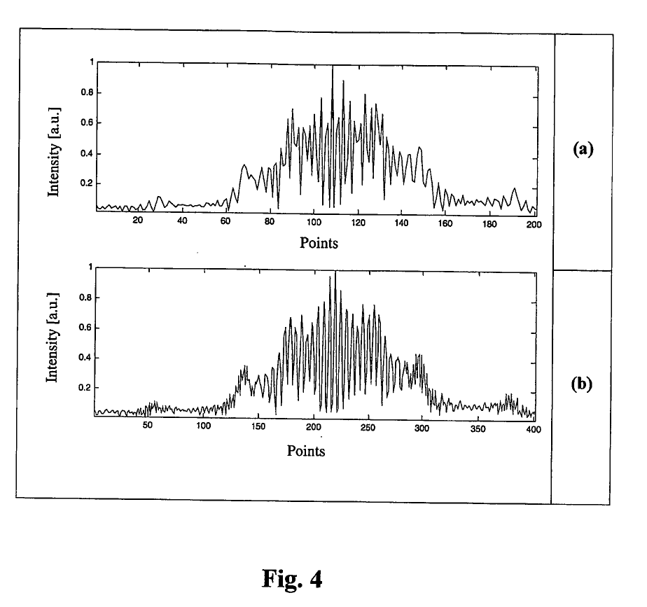

FIG. 4a shows a particular information related to the reconstruction of FIG. 3a, in relation to a certain reconstruction distance, as a function of the number of pixels;

FIG. 4b shows a particular information related to the reconstruction of FIG. 3b, in relation to a certain reconstruction distance, as a function of the number of pixels; and

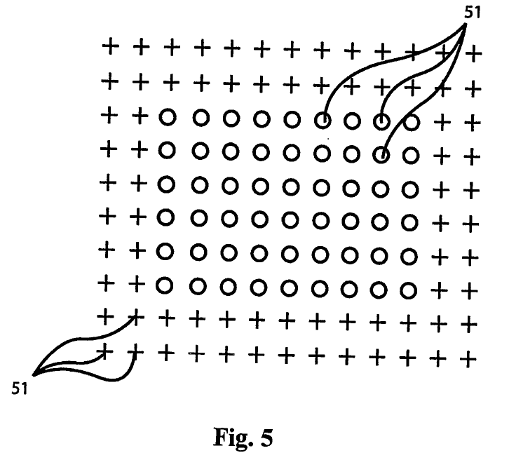

FIG. 5 shows a preferred arrangement of the null pixels used in the method according to the invention.

As mentioned before, digital holography consists of recording a distribution of interference, which is created between an object beam (that has interacted with the object under observation) and a reference beam, through an ad hoc system for acquiring images.

Such interference distribution is processed through processing methods apt to reconstruct an image of the object under observation.

In particular, the recorded hologram is multiplied by a digital replica of the reference beam and the diffraction integral of this product is calculated. Such hologram allows a reconstruction of the object under observation to be obtained.

The reflection holographic recording apparatus may be for instance of the Mach-Zehnder type. Once analogue data are acquired, they are processed by a processing unit.

Making reference to FIG. 1, such processing unit processes data according the traditional method. The unit of preparation of hologram acquisition conditions or “set-up” 2 collects radiation 4 coming from source 1 and illuminate with radiation 5 the object 3 under observation. Also, in such set-up 2 is present a device for creating, from the beam 6 that is reflected, transmitted or scattered by the object 3, an object beam O, and a device for creating a reference beam R. The object beam O and the reference beam R are combined in the set-up 2 so as to create an interference distribution 7 in a plane. Such interference creates the hologram 8 of the object 3 under observation, and it may be described in terms of bidimensional distribution of intensity:
H(x, y)=|R|²+|O|²+R*O+RO*

where R* and O* represent the conjugate complex of the reference beam and of the object beam, respectively.

It is now necessary to specify that, as it will be shown later, the method according to the present invention is not restricted to the optical field and it may be applied for the numerical reconstruction of holograms recorded with any type of electromagnetic (for instance X rays) and non-electromagnetic radiation (for instance electron beams and/or acoustic waves). In particular, source 1 could be also made of a combination of two or more wavelengths. For this reason, type, wavelength and coherence of source 1 could be any.

The hologram 8 is acquired, digitized and stored through an acquisition system 9. To this end, any type of existing or future image acquisition system may be used.

The acquisition system 9 internally has a device for digitizing and computer storing the acquired image 8. The digitized image is called “digital hologram” 10 and it is described by an array H(n·Δx,m·Δy) of N·M numbers, obtained by the bidimensional spatial sampling of the hologram H(x,y) 8.

Tale bidimensional spatial sampling may be described by the following formula:

$$H ( n Δ x , m Δ y ) = H ( x , y ) rect ( \frac{x}{N Δ x} , \frac{y}{M Δ y} ) {\sum }_{n = 1}^{N} {\sum }_{m = 1}^{M} δ ( x - n Δ x , y - m Δ y0 )$$

where δ(x,y) is a bidimensional Dirac delta function, n and m are integer, Δx and Δy are the sampling spacings along the x-axis and the y-axis respectively, (N·Δx)×(M·Δy) is the area of the image of the acquired hologram, rect(x,y) is a function the value of which is 1, if the point of coordinates (x,y) is within the part of the acquired hologram, and 0 otherwise.

For a perfect reconstruction of the object image, it is necessary that the digitization process satisfies the sampling theorem. In particular, it has to be satisfied the condition that the spacing between the fringes present in the interference distribution 7 is larger than at least two pixels of the acquisition system 9. Hence, the sampling theorem establishes the minimum resolution that is obtainable with a certain experimental set-up 2.

One of the great advantages offered by the digital holography is the fact that it is possible to directly act on the digitized hologram 10 of the object 3 for carrying out operations on the acquired information.

This means that different processings of the images 11 may be made on the digitized hologram 10. Through such processings, it is for example possible to eliminate zero order diffraction present in hologram reconstruction, or to eliminate any “phase aberration” introduced by the used optical system.

The term “phase aberration” means a deformation of the wave front travelling through the hologram creation ad recording system. The phase aberration correction compensates such deformations and allows obtaining a correct reconstruction of the observed object.

The process of numerical reconstruction 13 of the object under observation is based on two steps. In the first one, the “processed” digitized hologram H(n,m) 12 has to be multiplied by a digitized replica of the reference beam R, obtaining the following formula:
F(nΔx,mΔy)=H(nΔx,mΔy)·R(nΔx, mΔy)==R|R|²+R|O|²+RR*O+RRO*

where the first two terms correspond to the zero order diffraction, and from the third and/or fourth term it is possible to obtain the image of the observed object.

The second step of the propagation process consists of the propagation of the field distribution F(n,m) from the plane wherein the camera is placed to the observation plane. This process leads to the reconstructed image 14.

It is then possible to numerically act on the recorded and stored digitized hologram through an electronic device for image acquisition (hereinafter generically called as camera) made of a discrete set of sensitive elements arranged in the shape of array of N rows and M columns, in order to obtain a higher spatial resolution with respect to the techniques presently in use.

In order to overcome the aforementioned drawbacks of the traditional method, the method according to the present invention is based on the extension of the array of the object hologram by introducing a number of additional fictitious points, the intensity of which is set to zero.

The object is then reconstructed with the technique of the hologram numerical propagation from the camera plane along the distance separating the object from the same plane of the camera.

The hologram propagation occurs by using the bidimensional Fresnel transform. The advantage of such integral is that its computation is simple and may be very fast performed by using a discrete formulation expressed in terms of Fourier transform. In fact, it is well known (see Goodman, “Introduction to Fourier Optics”, MacGraw-Hill Companies Inc., 2nd ed., 1996) that the phenomenon of light propagation from a starting plane to a parallel plane placed at a distance d may be interpreted as a space-invariant linear system characterised by a transfer function having a finite band amplitude. Such transfer function has unitary module and phase depending on the spatial frequencies corresponding to the two orthogonal directions within the plane placed at a distance z from the starting plane.

In case of propagation of an optic field through the Fresnel numerical integral, the transfer function phase quadratically depends on the spatial frequencies. Consequently, dispersive effects are introduced in the hologram numerical reconstruction process which increase with the increase of the reconstruction distance and which generally contribute to make the reconstructed hologram spatial resolution worst.

As it will be clarified in the following, the extension of the dimension of the hologram array, by adding null elements, allows acting on the size of the minimum element composing the object reconstructed image (the “reconstruction pixel”), rather improving its resolution.

Making reference to FIG. 2, as in the traditional case, for carrying out the method according to the invention it is first of all necessary to have a holographic system for creating a hologram of the object under observation.

Such hologram is digitized and computer stored through a camera. The digitized hologram is a rectangular array obtained by sampling the hologram by means of the camera with a step Δx along the x-axis and a step Δy along the y-axis (Δx and Δy coincide with the camera pixel size) for a number of points equal to N·M (N is the number of camera pixels along the x-axis and M is the number of camera pixels along the x-axis).

The array size related to the digitized hologram is then enlarged by adding a suitable number of points so as to obtain the desired resolution in the hologram reconstruction process.

By using such extended array, it is then possible to exploit the technique of the bidimensional Fresnel transform for reconstructing the image of the object under observation, so gaining in definition.

In the configuration preferred by the inventors, set-up 2 is designed so as to produce a “Fresnel hologram”, term indicating a hologram that may be reconstructed through Fresnel scalar diffraction approximation.

The advantages of such approximation derives from the fact that its computation is very simple and may be performed in a very fast manner. In case of Fresnel approximation, numerical reconstruction of the hologram 12 will be carried out according to the invention through a discrete formulation of the Fresnel integral expressed in terms of discrete Fourier transform, that is:

$$ψ ( l Δ x , k Δ y ) = A {ⅇ}^{\frac{i π}{λ d} ( {l}^{2} Δ {ξ}^{2} + {k}^{2} Δ {η}^{2} )} {DFT [ R ( n Δ x , m Δ y ) H ( n Δ x , m Δ y ) {ⅇ}^{\frac{i π}{λ d} ( {n}^{2} Δ {x}^{2} + {m}^{2} Δ {y}^{2} )} ]}_{l , k}$$

where λ is the wavelength of source 1, A is a complex constant, n, m, l, k are integer (−N/2≦n,/≦N/2 and −M/2≦m,k≦M/2), DFT is the discrete Fourier transform, which may be fast computed by making use of multiple FFT (Fast Fourier Transform) algorithms reported in literature, Δx and Δy are the sampling spacings of the hologram 12 (hence in the camera plane), d is the distance between the camera plane and the observation plane, and, finally, Δξ and Δη represent the sampling spatial intervals in the observation plane which are defined by:

$$Δ ξ = \frac{λ d}{N Δ x} \\ Δ η = \frac{λ d}{M Δ y} \qquad ( 1 )$$

Hence, the reconstructed object will have size (N·Δξ)×(M·Δη). The intervals described by equations (1) substantially define the resolution of the reconstructed object 14.

As it may be noted from the preceding formula, the resolution also depends on, besides the number of pixels and the resolution of the acquisition system 9, the wavelength λ of the source 1 and the reconstruction distance d.

In the reconstruction processes, it is generally ΔξΔx and Δη>Δy, i.e. the reconstructed object image is characterised by an inferior resolution with respect to the one with which the hologram 8 has been digitized and recorded.

As shown in the following, the method according to the invention allows solving the aforesaid problem and, under parity of wavelength and reconstruction distance d, improving the resolution of the image of the reconstructed object 14.

Always making reference to FIG. 2, on the one hand, the proposed method allows the system of creation and recording of the hologram 8 not to be modified, and, on the other hand, it is compatible for applications wherein the hologram recording has to be carried out in real time and in a continuous way.

In the version presently preferred by the inventors, the method acts on the processed hologram 12, that is on the hologram which has been already subject to processing for a correct reconstruction of the object 3.

The size of the array describing the digitized hologram 12 is expanded during step 15 by adding a certain number of points as determined in step 16.

The number of points to be added 16 is determined by the resolution 17 that is desired to obtain in the reconstruction process 13.

The value of such resolution 17 may be given either by conditions established by requirements 18 external to the reconstruction process 13 (for instance for observing with higher accuracy the object image) or for compensating the loss of resolution 19 due to the reconstruction process in applications requiring, in particular, the variation 20 of λ and/or d.

The number of points is not the only feature allowing a resolution improvement to be subsequently obtained.

In fact, it is needed to place the introduced fictitious points (i.e. the difference between the points computed as above and the acquired points) in a suitable way with respect to the detected points.

It is needed to be sure that the introduced zeros do not result in a transformed image (according to the function Ψ(l·Δx,k·Δy) described above) presenting false frequencies.

For example, placing zeros among not null values of a sinusoidal plot would clearly introduce frequencies far apart from the one of the sine.

Although single particular arrangements could be suitably adopted in specific cases, the preferred arrangement according to the invention is the one having the fictitious points as contour of the detected image, that is without interspersing them among the effective points.

Making reference to the example of FIG. 5, the fictitious points 50 are arranged symmetrically with respect to the contour of pixels 51 of the detected image.

This contour arrangement is proper to images in any number of dimensions.

The classical reconstruction process 13 is then applied to the expanded array of the hologram.

The expansion 15 of the array size of the hologram 12 allows obtaining, thanks to the DFT properties, a reconstructed image with a lower spacing (that is with a better resolution) with respect to the reconstruction obtained without expanding the array.

In other words, the traditional reconstruction process based on the Fresnel transform implies a degradation of the resolution with which the object is reconstructed; instead, the addition according to the invention of new elements in the hologram array allows such resolution loss to be corrected at most obtaining a resolution equal to the physical one established by the sampling theorem.

In particular, if it is desired to obtain an image of the reconstructed object 14 with the same resolution of the digitized hologram 10, under parity of wavelength λ and reconstruction distance d, it is necessary to expand the array of the hologram 12 from size N·M to size (dλ/Δx²)·(dλ/Δy²), as it is obtained by inverting formulas (1).

It would be theoretically possible to indefinitely improve the resolution of the holographic image by still adding new fictitious points. Actually, since the Fresnel transform re-distributes the intensity over all the points, beyond a certain number of fictitious points the intensity of many ones would be lowered below the background noise of the signal or the statistical noise of the same. However, it is matter of simple computation to determine the maximum number of fictitious points usable in any specific situation.

In FIG. 3 an example of application of the aforesaid method is reported. Such example is related to a coherent and monochromatic light source 1 with emission wavelength λ=532 nm, the observed object 3 is a Ronchi grating with step Λ=6.25 lines/mm, the acquisition and storing system is a CCD with N=512 and M=512 pixels and with square pixel size equal to Δx=Δy=6.7 μm. A Ronchi grating illuminated with monochromatic light generates the known Talbot effect, i.e. by observing the light scattered by the grating at increasingly long distances the grating rows appear increasingly defocused, save that at particular distances (multiple of the so-called Talbot distance, i.e. Λ²/λ), where the rows appear well defined and focused again. Hence, by using such effect, we are allowed not to handle focusing problems.

In particular, the holographic reconstruction of a single line of the aforesaid grating, the hologram of which has been recorded at an effective distance of 170 mm, is reported in FIG. 3a for several values of the distance d between hologram plane and observation plane.

The marks placed on the figure show the distances at which, due to Talbot effect, it is necessary to observe the grating rows well defined and focused.

The typical “trumpet” shape of FIG. 3a, obtained by varying distance d, is an indication of the reduction of the reconstruction pixel, according to equations (1).

The reduction of the reconstruction pixel, and hence of the reconstructed image resolution, under increasing distance d, prevents the grating rows to be sharply observed; hence, there is an information loss with the increase of the reconstruction distance.

The method according to the invention allows such information to be recovered.

The holographic reconstruction of the expanded hologram of the Ronchi grating is reported in FIG. 3b for the same values of distance d used in FIG. 3a.

In particular, hologram size has been increased by 512 points along both x-axis and y-axis, hence obtaining a hologram of 1024·1024 pixels. Obviously, the obtained shape is still a “trumpet” one, but it is possible to observe that by increasing the reconstruction distance it is still possible to determine distances at which the grating rows well defined and focused again. For better pointing out the advantage given by the present reconstruction method, a line is reported in FIG. 4a and FIG. 4b at a certain reconstruction distance (d=434 mm), related to FIG. 3a and FIG. 3b, respectively. The difference between such distance and the recording distance (170 mm) is multiple of the Talbot distance, and the grating rows should then appear well defined.

But observing FIG. 4a, it is noted that the loss of resolution does not allow the grating rows to be sharply distinguished.

The application of the method subject of the present invention allows overcoming such degradation. In fact, observing FIG. 4b, wherein the reconstruction of the grating expanded hologram has been carried out, it is noted that the grating rows are well visible and sharp.

The reconstruction method according to the invention represents a significant improvement with respect to the other methods present in literature. In fact, the method according to the invention acts on the object digitized hologram, and it may adapt the resolution of the object reconstructed image to the various requirements of multiple applications.

The invention is particularly, but not exclusively, intended for reconstruction processes in digital holography where there is the need to improve the resolution with which the complex field (amplitude and phase), transmitted or reflected or scattered by the object, is reconstructed, or to keep constant such resolution when the variation of other parameters, of which the same reconstruction is function, would tend to make the resolving power of the holographic technique worst. In numerous, above all metrological, applications, there exists the need to improve the resolution with which an object is observed, modifying as less as possible the observation apparatus and preventing the acquisition times from increasing. This last requirement is particularly felt in all those applications where a real time observation of the object is required.

The preferred embodiments have been above described and some modifications of this invention have been suggested, but it should be understood that those skilled in the art can make variations and changes, without so departing from the related scope of protection, as defined by the following claims

1. Method for the reconstruction of holographic images, the holographic image being detected by an image detection device, the holographic image being transformed in a digitized hologram, the digitized hologram being made of a number Vᵣ of signal intensity values corresponding to as many elementary sub-images or “pixels” of the holographic image, the pixel sizes being equal to the holographic image sampling intervals, the method comprising a first step of processing the digitized hologram array, and a second step of hologram reconstruction in the complex plane starting from the digitized hologram processed in the first step, the method being characterised in that the second step is carried out through discrete Fresnel transform starting from an array of Vₑ values, comprising said Vᵣ values and an integer number p=Vₑ−Vᵣ>0 of constant values equal to OS, corresponding to as many pixels of sizes equal to the ones of the others.

2. Method according to claim 1, characterised in that said p constant values are null values (OS=0).

3. Method according to claim 1 or 2, characterised in that said p values are arranged externally to said array of Vᵣ values.

4. Method according to claim 3, characterised in that said p values are arranged in a symmetrical way.

5. Method according to claim 3, characterised in that said p values are arranged in a non-symmetrical way.

6. Method according to any one of claims 1 to 5, characterised in that said number Vₑ of values is inversely proportional to the desired pixel size to be obtained for the reconstructed image.

7. Method according to any one of the preceding claims, characterised in that the digitized hologram is a square array of Vᵣ=NᵣMᵣ values, each value corresponding to a square pixel of sizes Δx, Δy.

8. Method according to claim 7, characterised in that the hologram reconstructed in the second step is represented by a square array of Vₑ=NₑMₑ values, each value corresponding to a square pixel of sizes Δξ=(λd/NₑΔx) and Δη=(Δd/MₑΔy), λ being the wavelength of the wave beam striking the object of which the hologram is recorded, and d the distance between the detection device and the object of which the hologram is detected, Δλ and Δη being the reconstructed holographic image sampling intervals.

9. Method according to claim 8, characterised in that Nₑ=(λd/Δx²), Mₑ=(λd/Δy²), Δξ=Δx, Δη=Δy.

10. Method according to any one of the preceding claims, characterised in that, after the second step, if each holographic image sampling interval is not equal or less than a certain threshold, the number of values p added to the digitized hologram array is increased and the second step is carried out again.

11. Method according to claim 10, characterised in that said threshold is a function of the signal-to-noise ratio of the holographic image.

12. Computer program characterised in that it comprises code means apt to execute, when running on a computer, the method according to any one of claims 1 to 11.

13. Memory medium, readable by a computer, storing a program, characterised in that the program is the computer program according to claim 12.

14. Apparatus for detection of holographic images, comprising a digitized hologram processing unit, characterised in that the processing unit processes the detected data by using the method according to any one of claims 1 to 11.
